(19) United States
(12) Patent Application Publication
(10) Pub. No.: US 2012/0137152 A1
(43) Pub. Date: May 31, 2012

(54) REDUCTION OF POWER CONSUMPTION FOR DATA ERROR ANALYSIS

(76) Inventors: Itai Dror, Omer (IL); Alexander Berger, Mizpe Ramon (IL); Michael Mostovoy, Cupertino, CA (US); Yoav Weinberg, Haifa (IL)

(21) Appl. No.: 13/313,669

(22) Filed: Dec. 7, 2011

Related U.S. Application Data
(63) Continuation of application No. PCT/US2011/022872, filed on Jan. 28, 2011.
(60) Provisional application No. 61/417,746, filed on Nov. 29, 2010.

(51) Int. Cl. G06F 1/32; G06F 11/00

(52) U.S. Cl. 713/322

(57) ABSTRACT

A controller (e.g., a memory controller) includes initial error analysis logic (e.g., a section of a Reed Solomon or BCH codeword decoder) that determines an error count for a data element. The data element may be data stored in the memory of a memory device (e.g., a flash memory device) that incorporates the controller. Comparison logic in the controller determines when the error count exceeds a power control threshold. When the error count exceeds the power control threshold, control logic in the controller reduces the operational speed of subsequent error analysis logic (e.g., a different section of the Reed Solomon or BCH codeword decoder) for the data element. For example, the subsequent error analysis logic may be error locator logic, such as Chien search logic, that determines where the errors exist in the data element.

### CROSS-REFERENCE TO RELATED APPLICATIONS

This application is a continuation of PCT Application No. PCT/US2011/022872, filed Jan. 28, 2011, which claims the benefit of U.S. Provisional Patent Application No. 61/417,746, filed Nov. 29, 2010, both of which are hereby incorporated by reference herein.

### BACKGROUND OF THE INVENTION

1. Technical Field

This disclosure relates to reducing power consumption in electronic devices that include error decoders. In particular, this disclosure relates to reduction in peak power consumption in memory devices that perform error detection and correction on the data elements that they store.

2. Related Art

Continual development and rapid improvement in semiconductor manufacturing techniques have led to extremely high density memory devices. The memory devices are available in a wide range of types, speeds, and functionality. Memory devices often take the forms, as examples, of flash memory cards and flash memory drives. Today, capacities for memory devices have reached 64 gigabytes or more for portable memory devices such as Universal Serial Bus flash drives and one terabyte or more for solid state disk drives. Memory devices form a critical part of the data storage subsystem for digital cameras, digital media players, home computers, and an entire range of other host devices.

One important characteristic of a memory device is its power consumption. In an age when many host devices are powered by limited capacity batteries, every fraction of a watt in power saving translates into extended battery life and extended functionality between recharges for the host device. Reliability and cost are also important characteristics of a memory device. Significant volumes of memory devices are manufactured and sold each year, and competitive pressures have resulted in very low cost and even lower margins. Accordingly, even small improvements in the cost of a memory device can yield significant financial and marketplace position benefits. At the same time, low cost cannot be achieved at the expense of reliability. Instead, consumers expect that their memory devices will store their data for extended periods of time without significant risk of data loss.

### SUMMARY

In one implementation, a controller includes initial error analysis logic (e.g., a section of a Reed Solomon or BCH codeword decoder) that determines an error count for a data element. The data element may be data stored in the memory of a memory device (e.g., a flash memory device) that incorporates the controller. Comparison logic in the controller determines when the error count exceeds a power control threshold. When the error count exceeds the power control threshold, control logic in the controller reduces the operational speed of subsequent error analysis logic (e.g., a different section of the Reed Solomon or BCH codeword decoder) that performs error analysis on or for the data element. For example, the subsequent error analysis logic may be error locator logic, such as Chien search logic, that determines where the errors exist in the data element.

In another implementation, a method performs data error analysis. The method includes submitting a data element to initial error analysis logic and obtaining an error count for the data element from the initial error analysis logic. The method then determines when the error count exceeds a power control threshold. When the error count exceeds the power control threshold, the method reduces operational speed of subsequent error analysis logic for the data element.

Other features and advantages of the inventions will become apparent upon examination of the following figures, detailed description, and claims.

### BRIEF DESCRIPTION OF THE DRAWINGS

The system may be better understood with reference to the following drawings and description. In the figures, like reference numerals designate corresponding parts throughout the different views.

FIG. 1 illustrates prior art error decoding logic.

FIG. 2 illustrates prior art error search logic that may be included in the error decoding logic shown in FIG. 1.

FIG. 3 shows a probability curve of the probability of decoding more than a specified number of errors in a code word.

FIG. 4 shows a controller that controls power consumption of error decoding logic.

FIG. 5 shows a controller that controls power consumption of error decoding logic.

FIG. 6 shows an alternative implementation of control logic configured to control power consumption of error decoding logic.

FIG. 7 shows an alternative implementation of control logic configured to control power consumption of error decoding logic.

FIG. 8 shows a method for controlling power consumption of error decoding logic.

### DETAILED DESCRIPTION OF THE PREFERRED EMBODIMENTS

The discussion below makes reference to host devices and memory devices. A host device may be a wired or wireless device and may be portable or relatively stationary and may run from battery power, AC power, or both. A host device may be a consumer electronic device such as a personal computer, a mobile phone handset, a game device, a personal digital assistant (PDA), an email/text messaging device, a digital camera, a digital media/content player, and a GPS navigation device, satellite television receiver, cable television receiver. In some cases, a host device accepts or interfaces to a memory device that includes the functionality described below. Examples of memory devices include memory cards, flash drives, and solid state disk drives. For example, a music/video player may accept a memory card that incorporates the functionality described below, or a personal computer may interface to a solid state disk drive that includes the functionality described below. In other cases, the host device may directly incorporate the logic that implements the functionality described below.

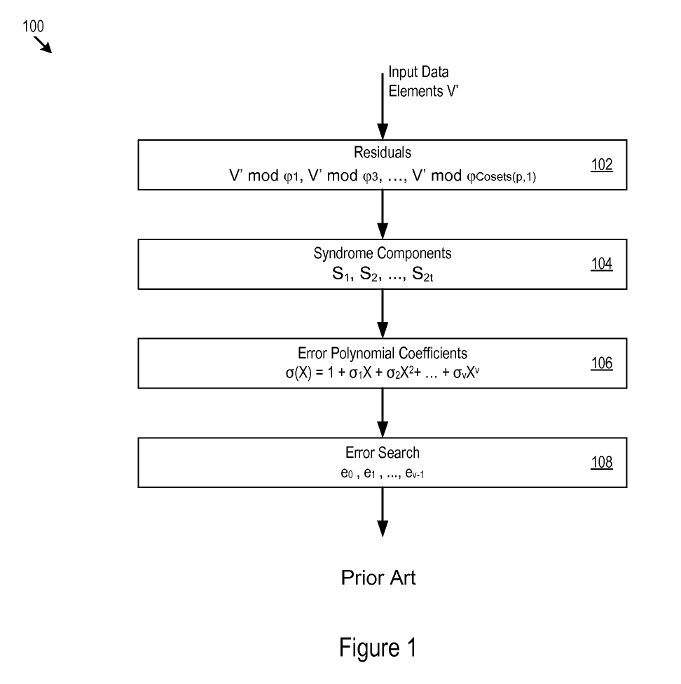

FIG. 1 illustrates prior art error decoding logic 100 that may be present in a host device or a memory device. In particular, the error decoding logic 100 is a block diagram of the functionality of a Bose, Chaudhuri, and Hocquenghem (BCH) error decoder. The innovations described in this application are not limited to BCH decoders, but may instead be applied to any error detection or correction logic, including Reed-Solomon decoders, turbo decoders, low density parity check decoders, and other error detection or correction logic.

The error decoding logic 100 is partitioned into four stages 102, 104, 106, and 108. A possibly corrupted data element V′ is submitted, word by word, to the first stage 102. The first stage 102 determines ‘p’ residuals, bᵢ, from the input data element with respect to ‘p’ minimal polynomials, φᵢ. The ‘p’ residuals are submitted to the second stage 104, which calculates the ‘2t’ syndrome components from the ‘p’ residuals calculated at the first stage 102, where ‘t’ is the maximum number of correctable errors supported by the decoder. The third stage 106 calculates the coefficients of the error location polynomial from the ‘2t’ syndrome components that were determined by the second stage 104. The third stage 106 may employ, for example, the Berlekamp-Massey method to solve for the coefficients. The outputs of the third stage 106 are the ‘v’ coefficients of the error locator polynomial, where ‘v’ is the number of errors determined to be present in the input data element V′. The fourth stage 108 locates the ‘v’ errors in the input data element V′ by solving the error locator polynomial. The fourth stage 108 may be implemented as Chien search logic, for example, that outputs the additive inverses of the error locations.

The Chien search circuit in the fourth stage 108 may find the bit addresses of the errors by locating the zeros, ‘e’, of the error location polynomial. The third stage 106 outputs the number of errors found, ‘v’, in the input data element V′, and the ‘v’ coefficients σᵢ of the error locator polynomial. This data is input to the Chien search circuit.

In summary, a data element is input to initial error analysis logic (e.g., stages 102, 104 and/or 106). The initial error analysis logic determines an error count for the data element. Subsequent error analysis logic (e.g., stage 108) locates the errors in the data element. The initial error analysis logic need not be the first error analysis logic encountered by a data element in a decoder. Similarly, the subsequent error analysis logic need not be the last error analysis logic in the decoder, nor does the subsequent error analysis logic need to immediately follow the initial error analysis logic. Rather, the subsequent error analysis logic may follow the initial error analysis logic after one or more intermediate stages.

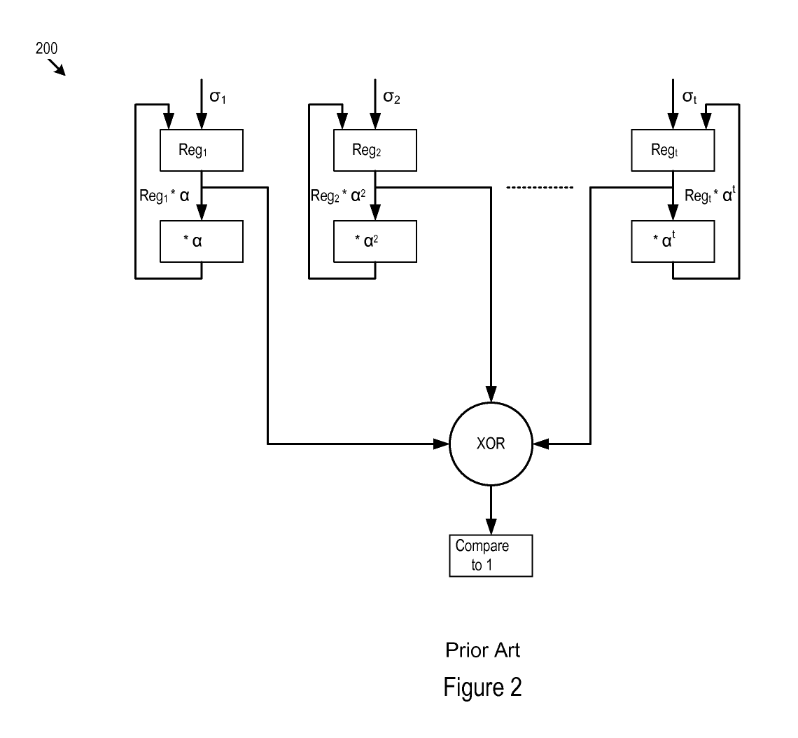

FIG. 2 shows one implementation of error locator logic in the form of a Chien search circuit 200. The Chien search circuit 200 includes ‘t’ multipliers that multiply by the constants α, α², . . . , α^{t} where ‘t’ is the maximum number of correctable errors for the code. Typically, the actual number of errors, in a data element is smaller than the maximum error correction capability of the code, ‘t’. As a result, ‘v’ of the ‘t’ multipliers are typically active, with <‘t’, in the search for the locations of the errors in the data element. The Chien search circuit 200 may be implemented in hardware, with hardware registers and hardware multipliers, as examples, or may be implemented in software as processor executable instructions, or may be implemented as a combination of hardware and software.

The Chien search circuit 200 consumes a substantial part of the power consumption of the error decoding logic 100. Because more multipliers are active as more errors are detected in the data element, the power consumption of the Chien search circuit 200 is a function of the number of detected errors in the data element. Maximum power is consumed when there is the maximum number of errors, ‘t’, in the data element, because all the ‘t’ multipliers are then active. More generally, the power consumed by Chien search circuit 200 is a monotonically increasing function of the number of decoded errors in the data element.

The power supply for the host device or memory device that includes the error decoder must be designed to deliver the maximum sustained power required, which includes the worst case power consumption by the error decoding logic. Thus, the power supply is designed to deliver the power needed to run all ‘t’ multipliers in case the data element includes ‘t’ errors. However, it is unlikely that there will be large numbers of errors, approaching ‘t’, in the data element.

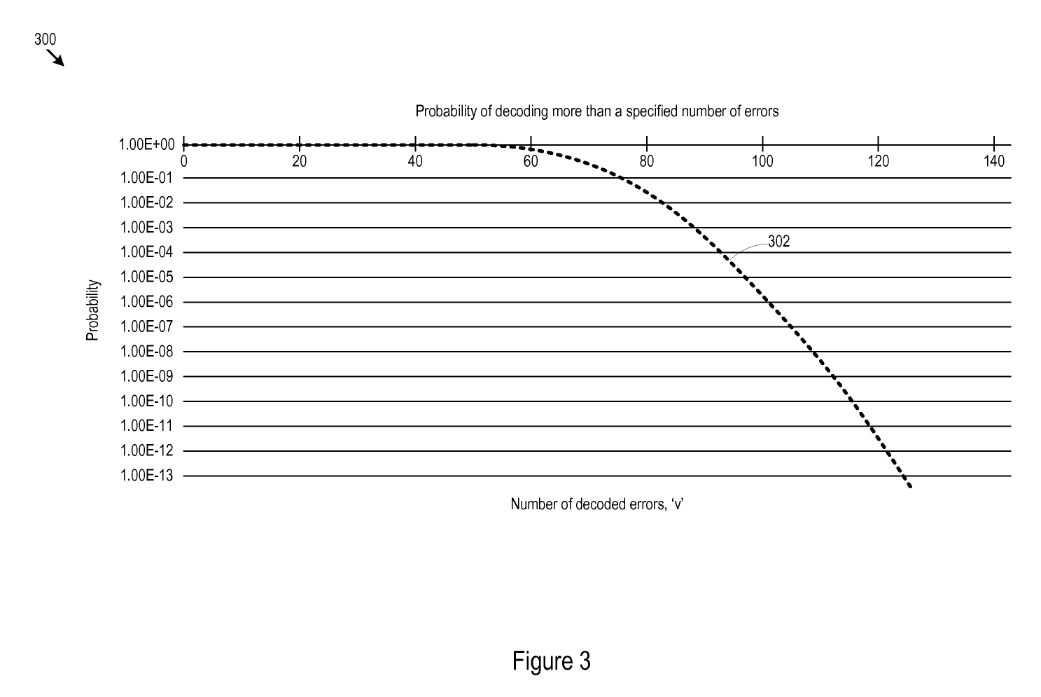

FIG. 3 shows an example plot 300 that gives the probability 302 that a data element will have more than a specified number of errors. For the purposes of illustration, the plot 300 assumes a BCH(18214, 16384, 245) code that corrects up to 122 errors in a code word, and a bit error rate of 0.34%. The BCH(18214, 16384, 245) code specifies that each code word will have 18,214 bits, of which 16,384 are data bits (e.g., a block of 2048 8-bit bytes of user data), and that there is a minimum Hamming distance of 245 between code words. Other such plots may be generated for any particular code design and bit error rate, and the data elements input to the error detection or correction logic may be code words from any desired code design.

The plot 300 shows, for example, that there is less than a 1/1000 chance of the data element having more than 88 errors. The probability drops precipitously as the number of errors increases toward ‘t’, the maximum error correcting capability of the code. Although it is rare to have a large number of errors in the data element, the power supply needs to be designed to accommodate the power needed to correct these large numbers of errors.

The following description presents several techniques for reducing the maximum power consumption of error decoding logic. In one aspect, the operational speed of a portion of the error decoding logic is reduced when the number of detected errors, ‘v’, in a data element is greater than a power control threshold number of errors. The power control threshold may be a constant, or may be changed during the operation of the device that includes the error decoding logic. As a result, detecting and correcting a large number of errors occurs, for example, at a slower clock frequency, thereby decreasing the maximum sustained power consumption of the error decoding logic.

The power control threshold at which the slower operational speed occurs may be set at any level. In some implementations, the power control threshold may be set to correspond to a desired probability that fewer than the threshold number of errors will occur. As a specific example, using the code design given above, the power control threshold may be set to 88, so that there is only a 1/1000 chance that the slower operational speed is engaged for any given data element. As a result, the error decoding logic operates at full speed 999 times out of 1000, and the overall performance reduction of the error decoding logic is kept low. At the same time, the slower clock speed translates into reduced power requirements for the error decoding logic.

The reduced power requirements may give rise to less expensive or less complex power supplies, thereby reducing the cost and increasing the reliability of the electronic device that incorporates operational speed control over the error decoding logic. This is particularly true in implementations where the memory controller and the power supply are fabricated monolithically (e.g., on a single chip). In such implementations, the power supply relies on internal chip capacitance to avoid the expense and space required for discrete capacitors, but at the same time the power supply tends to be limited in peak power output, rise and fall time, and other parameters. Accordingly, reducing the power required from the power supply facilitates low cost and reliable fabrication and operation of memory devices that incorporate the power supply, e.g., on a single chip.

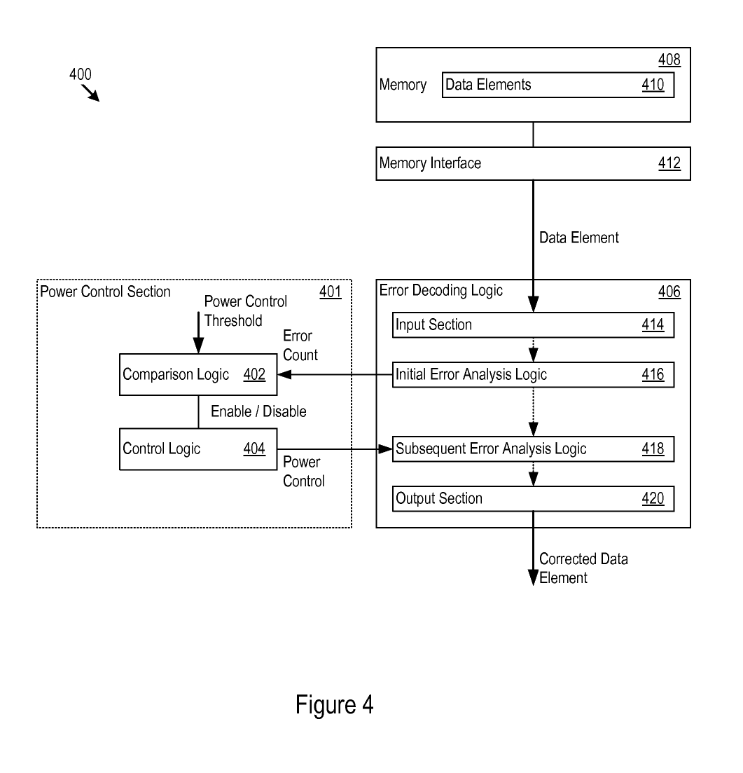

FIG. 4 shows a controller 400 that includes a power control section 401 to control power consumption of error decoding logic 406. The power control section 401 includes comparison logic 402 and control logic 404. The power control section 401 is in communication with the error decoding logic 406. A memory 408 stores data elements 410 that a memory interface 412 may communicate to the error decoding logic 406. As one example, the memory 408 may be a memory card memory array, and the controller 400 and memory interface 412 may respond to read requests from a host device by retrieving the requested data elements from the memory 408 and passing them to the error decoding logic 406. After error detection and correction, the corrected data elements may then be communicated to the host device.

A data element enters the error decoding logic 406 at the input section 414 and corrected data elements (or other data, such as error locations, that may be used to correct the data elements) exit at the output section 420. The initial error analysis logic 416 and subsequent error analysis logic 418 cooperate to perform error analysis on the data element. The initial error analysis logic 416 determines an error count for the data element. The comparison logic 402 is configured to determine when the error count exceeds a power control threshold. If so, as examples, the comparison logic 402 may assert a power control enable signal or status bit, or communicate a power control message or command to the control logic 404. The control logic 404 is in communication with the comparison logic 402 and is configured to reduce operational speed of the subsequent error analysis logic 418 when the error count exceeds the power control threshold (e.g., responsive to the power control enable signal).

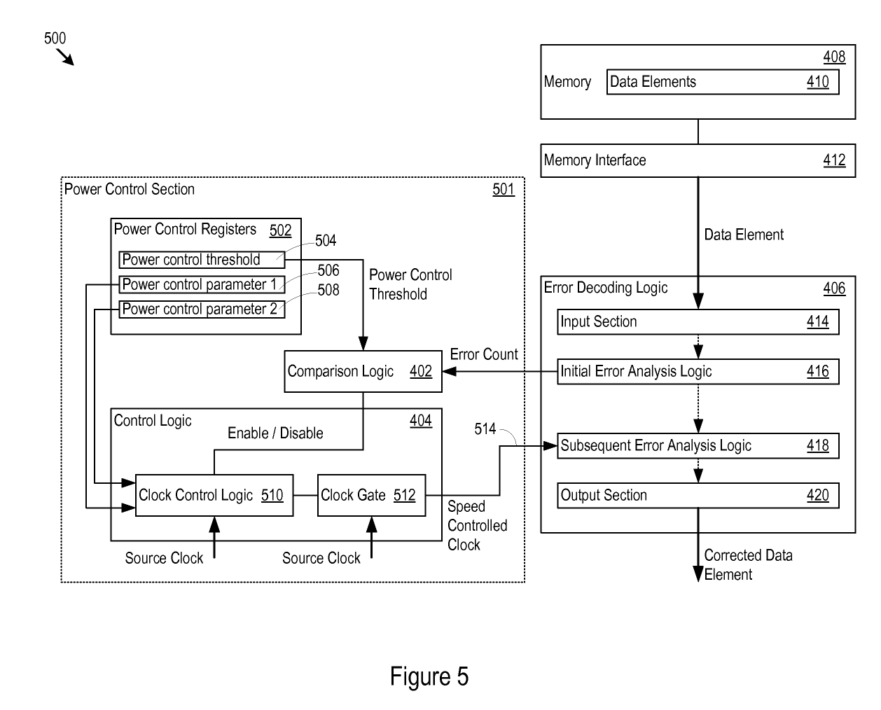

FIG. 5 shows another example of a controller 500 with a power control section 501 that controls power consumption of the error decoding logic 406. FIG. 5 shows that the power control section 501 includes power control registers 502, including a power control threshold register 504 and multiple power control parameter registers, two of which are illustrated as the first power control parameter register 506 and the second power control parameter register 508. Additional, fewer, or different power control registers may be provided. In this example, FIG. 5 shows that the control logic 404 includes clock control logic 510 and a clock gate 512.

The power control threshold register 504 may store the power control threshold for use by the comparison logic 402 as it determines when to assert the power control enable signal. The power control section 501 may specifically determine how to reduce operational speed of the error decoding logic 406 by reading the power control parameter registers 506 and 508 to obtain power control parameters. In one implementation, the clock control logic 510 reduces operational speed of the subsequent error analysis logic 418 as a function of the power control parameters. In that regard, the function may determine a speed reduction parameter, and the clock control logic 510 may reduce the speed of a source clock (e.g., using the clock gate 512 as discussed below) based on the speed reduction parameter to obtain a slower clock signal provided on the speed controlled clock line 514.

The clock control logic 510 may then clock the subsequent error analysis logic 418 with the slower clock signal. If the number of errors in the data element does not exceed the power control threshold, then the control logic 404 may clock the subsequent error analysis logic 418 at the full speed of the source clock (e.g., by passing the source clock through the clock gate 512 unaltered).

In one implementation, the clock gate 512 is an AND gate with the source clock as one input and a clock enable line as a second input. The clock gate 512 passes a fraction of the clock cycles of the source clock to the subsequent error analysis logic 418, thereby creating a slower clock form the source clock. For example, to reduce the previous maximum power consumption of the subsequent error analysis logic 418 by about 2, the clock control logic 510 may configure the clock gate 512 to pass 1 clock out of every 2 clocks from the source clock. The slower clock is half the speed of the source clock, resulting in about half of the previous power consumption for operating the subsequent error analysis logic to analyze the same number of errors.

In one implementation, the clock control logic 510 is programmable through the power control parameter registers 506 and 508. For the sake of explanation, these two registers are referred to as the SECC (Subsequent Enable Clock Count) register and the SDCC (Subsequent Disable Clock Count) register. The clock control logic 510 may be configured to enable (SECC+1) clocks out of (SECC+SDCC+2) clocks of the source clock. For example, if SECC is set to 1 and SDCC is set to 0, then the subsequent error analysis logic 418 will be clocked for 2 out of 3 clock cycles of the source clock. As a result, the peak power consumption of the subsequent error analysis logic will be reduced by ⅓.

In this example, the clock control logic 510 determines a function of the power control parameters as D=(SECC+1)/(SECC+SDCC+2), where D is the speed reduction parameter that specifies the speed reduction of the source clock. Other functions of additional, fewer, or different variables may be implemented.

One optimization that may be implemented for reduced peak sustained power consumption is to set the power control parameter registers 506 and 508 to a speed reduction at which the peak sustained power consumption of decoding the maximal number of errors, ‘t’ at the slower decoding speed is equal to the peak sustained power when decoding the number of errors specified in the power control threshold register 504. In other words, under this optimization, the subsequent error analysis logic 418 will not consume more than the amount of power needed to correct the power control threshold number of errors in the data element at full speed, even if there are more than that many errors in the data element.

Table 1 shows an exemplary comparison of measurements of maximal consumed power by the error decoder 100 as a whole, and for the Chien search circuit in the fourth stage 108 in particular, given a power control threshold of 88 errors and the code design described above with respect to FIG. 3. The example in Table 1 shows the power consumed for the following cases: decoding of 122 errors in the data element at the reference clock speed; decoding of 88 errors in the data element at the reference clock speed; and decoding of 122 errors in the data element at one-half of the reference clock speed for the Chien search circuit in the fourth stage 108.

TABLE 1

| | | Overall error decoder | Chien search circuit |
|---|---|---|---|
| | | maximum power | maximum power |
| Bit Errors | Clock Speed | consumption | consumption |
| 122 | Source | 91.4 mW | 57.0 mW |
| 88 | Source | 74.6 mW | 40.9 mW |
| 122 | Source/2 | 66.1 mW | 31.7 mW |

When the power control threshold register 504 is set to 88 errors, the decoding operations for more than 88 errors will be decoded at, in this example, half the source clock frequency. The maximum power consumption therefore is moved downward to the decoding operation for the power control threshold number of errors (88 in this example) at full speed. The maximum power required thereby decreases to:

max(decoding of 88 errors at full reference clock frequency, decoding of 122 errors at half the reference clock frequency)=max(74.6, 66.1)=74.6 mW.

As a result, the slower decoding operation executed whenever the number of decoded errors is beyond 88 reduces the maximum power consumption from 91.4 mW to 74.6 mW, or by 18.5%. The power control threshold register 504 may be set to any other value. Setting the power control threshold register 504 to a lower value results in further power reduction. Continuing the example given above, when the power control threshold is set to 82, for example, the subsequent error analysis logic runs more slowly about once for every 100 data elements rather than once for every 1000 data elements (see FIG. 3) which results in a reduction of maximum power consumption by about 25%.

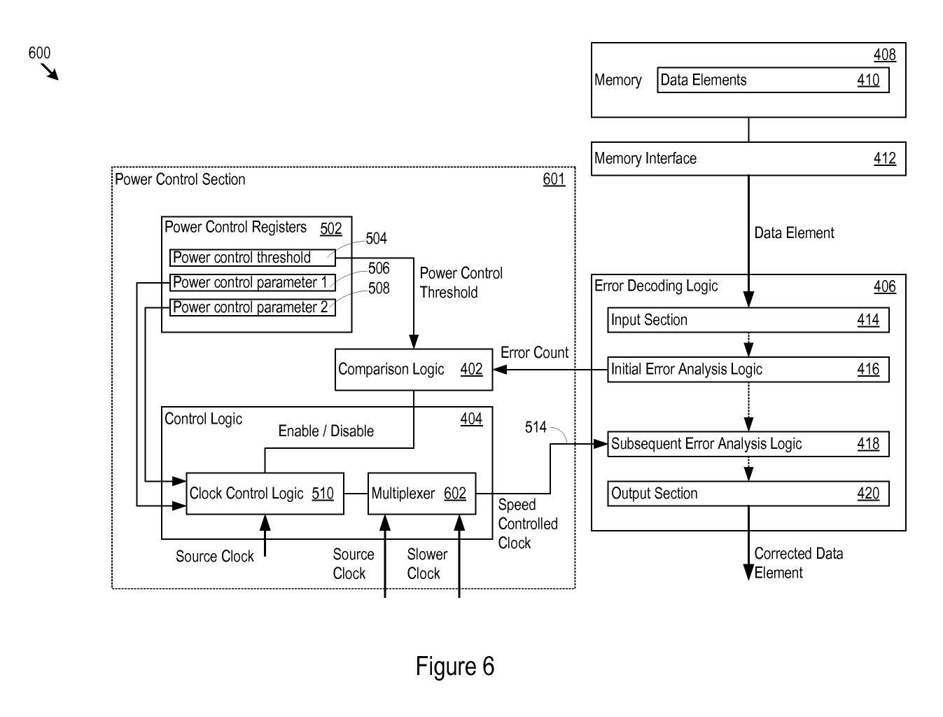

FIG. 6 shows an alternative implementation 600 of the control logic 404. In the implementation 600, the clock control logic 510 in the power control section 601 selects between multiple different clocks for the subsequent error analysis logic 418. More specifically, the clock control logic 510 may select, using a multiplexer 602 or other selector, which clock is applied to the subsequent error analysis logic 418. For example, when the number of errors in the data element is less than the power control threshold number of errors, the clock control logic 510 may select the source clock for the subsequent error analysis logic 418. Otherwise, the clock control logic 510 may select a secondary clock, e.g., a clock that is slower than the source clock.

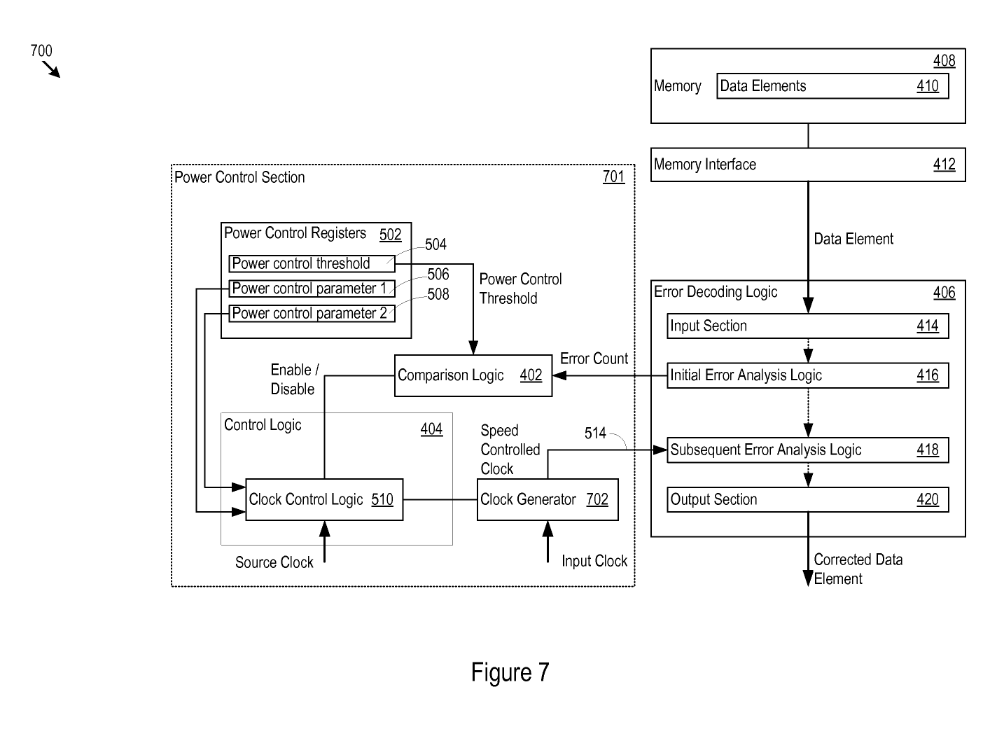

FIG. 7 shows another alternate implementation 700 of the control logic 404. In the implementation 700, the clock control logic 510 in the power control section 701 communicates with a clock generator 702. The clock generator 702 may be, for example, a programmable clock generator. The clock control logic 510 may select the clock speed for the speed controlled clock applied to the subsequent error analysis logic 418 by asserting clock generator control signals to the clock generator 702. For example, when the number of errors in the data element is less than the power control threshold number of errors, the clock control logic 510 may control the clock generator 702 to output a clock signal having a reference clock speed for the subsequent error analysis logic 418. Otherwise, the clock control logic 510 may control the clock generator 702 to output a clock signal having a slower clock speed than the reference clock.

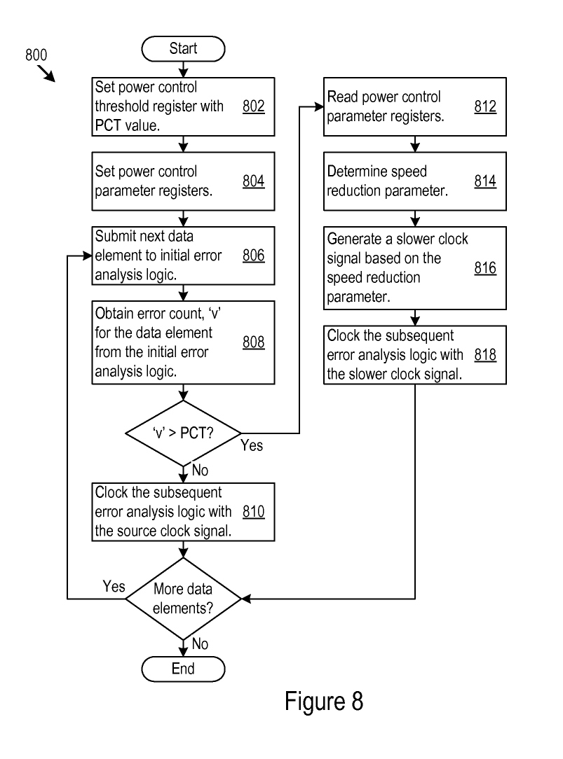

FIG. 8 shows a method 800 for controlling power consumption of error decoding logic. The power control threshold register is programmed with a value for the power control threshold (802), referred to as ‘PCT’ below. In addition, the power control parameter registers (e.g., the registers 506 and 508) are programmed with parameter values that will determine a speed reduction parameter based upon which a slower clock signal is generated from a source clock signal.

Parts (802) and (804) of the method 800 are optional. In other words, a given implementation may or may not include the power control threshold register 504, and may or may not include the power control parameter registers 506 and 508. Instead, a particular implementation may operate based on a fixed power control threshold value and a fixed speed reduction. For example, an implementation may always reduce the clock speed by one-third when there are more than 80 errors in a data element.

As the data elements are read from the memory 408, the controller submits the data elements to the initial error analysis logic (806). The initial error analysis logic determines an error count, ‘v’ for the data element and the controller obtains the error count (808). If ‘v’ is not greater than PCT, then the power control section clocks the subsequent error analysis logic with the source clock signal (810). More generally, the power control section does not reduce the operational speed of the subsequent error analysis logic, but permits the subsequent error analysis logic to run a normal operational speed.

However, if ‘v’ exceeds PCT, then the power control section reads the power control parameter registers 506 and 508 (if present) (812), and determines a speed reduction parameter (814). The speed reduction parameter may be a function of the power control values stored in the power control parameter registers, for example. For example, the function may determine the clock frequency of a slower clock signal as a percentage reduction in the clock frequency of a source clock. The power control section generates the slower clock based on the speed reduction parameter (816) and clocks the subsequent error analysis logic with the slower clock signal (818).

In other implementations, one or more of the power control parameters may determine which of multiple different speed clocks to apply to the subsequent error analysis logic. The controller may then use the parameter values to select between multiple different clocks using a multiplexer or other logic. In other cases, the power control parameters may specify programming bits or instructions for a programmable clock generator so that controller may obtain a specific slower clock signal for the subsequent error analysis logic by applying the parameters to a programmable clock generator or other logic.

Note that the subsequent error analysis logic may perform many different types of operations and is not limited to error location operations, or to performing a single type of operation. Similarly, the initial error analysis logic may determine characteristics of the data element in addition to or other than error count. The initial error analysis logic may then provide the determined characteristics to the logic that determines whether and how to slow the operational speed of the subsequent error analysis logic based upon the determined characteristic.

The methods, power control sections, controllers, and other logic described above may be implemented in many different ways in many different combinations of hardware, software or both hardware and software. For example, the logic shown in FIGS. 4-7 may be circuitry in a controller, a microprocessor, or an application specific integrated circuit (ASIC), or may be implemented with discrete logic, or a combination of other types of circuitry. The logic may be encoded or stored in a machine-readable or computer-readable medium such as a compact disc read only memory (CDROM), magnetic or optical disk, flash memory, random access memory (RAM) or read only memory (ROM), erasable programmable read only memory (EPROM) or other machine-readable medium as, for example, instructions for execution by a processor, controller, or other processing device. Similarly, the memory that stores the data elements may be volatile memory, such as Dynamic Random Access Memory (DRAM) or Static Random Access Memory (SRAM), or non-volatile memory such as NAND Flash or other types of non-volatile memory, or may be combinations of different types of volatile and non-volatile memory. The instructions that comprise the software may be part of a single program, separate programs, implemented in an application programming interface (API), in libraries such as Dynamic Link Libraries (DLLs), or distributed across multiple memories and processors. The instructions may be included in firmware that a controller executes. For example, the firmware may be operational firmware for a memory card whose read/write operations are directed by a controller. The controller may execute the instructions to perform all or part of the techniques described above. For example, the instructions may perform the comparison of ‘v’ and ‘PCT’, and responsively communicate with the programmable clock generator to generate the slower clock signal.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for reducing the power consumption of an electronic device that performs data error analysis, the method comprising:
submitting a data element to initial error analysis logic;
obtaining an error count for the data element from the initial error analysis logic; and
when the error count exceeds a power control threshold, reducing an operational speed of subsequent error analysis logic for the data element.

2. The method of claim 1, where reducing operational speed comprises:
reducing a clock speed for the subsequent error analysis logic.

3. The method of claim 2, where reducing a clock speed comprises:
generating a reduced clock speed clock signal from a source clock; and
clocking the subsequent error analysis logic with the reduced clock speed clock signal.

4. The method of claim 3, further comprising:
clocking the subsequent error analysis logic with the source clock when the error count does not exceed the power control threshold.

5. The method of claim 1, where responsively reducing operational speed comprises:
reading a power control register to obtain a power control parameter; and
reducing the operational speed based on the power control parameter.

6. The method of claim 5, where the power control parameter comprises a speed reduction parameter; and further comprising:
reducing speed of a source clock based on the speed reduction parameter to obtain a slower clock signal; and
clocking the subsequent error analysis logic with the slower clock signal.

7. The method of claim 1, where responsively reducing operational speed comprises:
reading multiple power control registers to obtain power control parameters; and
reducing the operational speed as a function of the power control parameters.

8. The method of claim 7, where the function determines a speed reduction parameter, and further comprising:
reducing speed of a source clock based on the speed reduction parameter to obtain a slower clock signal; and
clocking the subsequent error analysis logic with the slower clock signal.

9. The method of claim 1, where the subsequent error analysis logic comprises Chien search logic.

10. The method of claim 1, where submitting, obtaining, and reducing are all performed in a memory device that stores the data element.

11. The method of claim 1, where submitting, obtaining, and reducing are all performed in a host device operable to connect to a memory device that stores the data element.

12. A memory controller comprising:
a memory interface configured to connect to a memory that stores a data element;
initial error analysis logic in cooperation with subsequent error analysis logic to perform error analysis on the data element, with the initial error analysis logic configured to determine an error count for the data element;
comparison logic in communication with the initial error analysis logic, the comparison logic configured to determine when the error count exceeds a power control threshold; and
control logic in communication with the comparison logic, the control logic configured to reduce an operational speed of the subsequent error analysis logic when the error count exceeds the power control threshold.

13. The memory controller of claim 12, where the control logic is configured to reduce the operational speed by:
reducing a clock speed for the subsequent error analysis logic.

14. The memory controller of claim 12, where the control logic is configured to reduce the operational speed by:
generating a reduced clock speed clock signal from a source clock; and
clocking the subsequent error analysis logic with the reduced clock speed clock signal.

15. The memory controller of claim 14, where the control logic is further configured to:
clock the subsequent error analysis logic with the source clock when the error count does not exceed the power control threshold.

16. The memory controller of claim 12, further comprising a power control register; and where the control logic is further configured to:
read the power control register to obtain a power control parameter; and
reduce the operational speed based on the power control parameter.

17. The memory controller of claim 16, where the power control parameter comprises a speed reduction parameter; and where the control logic is further operable to:
reduce speed of a source clock based on the speed reduction parameter to obtain a slower clock signal; and
clock the subsequent error analysis logic with the slower clock signal.

18. The memory controller of claim 12, further comprising:
multiple power control registers; and where the control logic is further configured to:
read the multiple power control registers to obtain power control parameters; and
reduce the operational speed as a function of the multiple power control parameters.

19. The memory controller of claim 18, where the function determines a speed reduction parameter, and where the control logic is further configured to:
reduce speed of a source clock based on the speed reduction parameter to obtain a slower clock signal; and
clock the subsequent error analysis logic with the slower clock signal.

20. The memory controller of claim 12, where the subsequent error analysis logic comprises Chien search logic.

21. The memory controller of claim 12, where the memory interface, initial error analysis logic, comparison logic, and control logic are all included in a memory device that also includes the memory that stores the data element.

22. The memory controller of claim 12, where the memory interface, initial error analysis logic, comparison logic, and control logic are all included in a host device that connects to the memory that stores the data element.

23. A memory device comprising:
a host device interface configured to communicate with a host device;
a memory configured to store a data element;
a memory controller coupled to the memory and the host device interface, the memory controller comprising:
initial error analysis logic configured to determine an error count for the data element;
comparison logic in communication with the initial error analysis logic, the comparison logic configured to determine when the error count exceeds a power control threshold; and
control logic in communication with the comparison logic, the control logic configured to reduce an operational speed of subsequent error analysis logic for the data element, when the error count exceeds the power control threshold.

24. The memory device of claim 23, where the control logic is configured to reduce the operational speed by:
reducing a clock speed for the subsequent error analysis logic.

25. The memory device of claim 23, where the control logic is configured to reduce the operational speed by:
generating a reduced clock speed clock signal from a source clock; and
clocking the subsequent error analysis logic with the reduced clock speed clock signal.

26. The memory device of claim 25, where the control logic is further configured to:
clock the subsequent error analysis logic with the source clock when the error count does not exceed the power control threshold.

27. The memory device of claim 23, further comprising a power control register; and where the control logic is further configured to:
read the power control register to obtain a power control parameter; and
reduce the operational speed based on the power control parameter.

28. The memory device of claim 27, where the power control parameter comprises a speed reduction parameter; and where the control logic is further operable to:
reduce speed of a source clock based on the speed reduction parameter to obtain a slower clock signal; and
clock the subsequent error analysis logic with the slower clock signal.

29. The memory device of claim 23, further comprising:
multiple power control registers; and where the control logic is further configured to:
read the multiple power control registers to obtain power control parameters; and
reduce the operational speed as a function of the multiple power control parameters.

30. The memory device of claim 29, where the function determines a speed reduction parameter, and where the control logic is further configured to:
reduce speed of a source clock based on the speed reduction parameter to obtain a slower clock signal; and
clock the subsequent error analysis logic with the slower clock signal.

31. The memory device of claim 19, where the subsequent error analysis logic comprises Chien search logic.
